(19) United States
(12) Patent Application Publication
(10) Pub. No.: US 2022/0274545 A1
(43) Pub. Date: Sep. 1, 2022

(54) GROMMET

(71) Applicant: Caterpillar Inc., Peoria, IL (US)

(72) Inventors: Raghavan SRINIVASAGAM, Coimbatore (IN); Premkumar MANOHARAN, Chennai (IN)

(21) Appl. No.: 17/682,590

(22) Filed: Feb. 28, 2022

(30) Foreign Application Priority Data
Mar. 1, 2021 (IN) 202111008431

(51) Int. Cl. B60R 16/02; E02F 9/08; H01B 17/58

(52) U.S. Cl. CPC B60R 16/0222; E02F 9/0858; H01B 17/583

(57) ABSTRACT

A grommet is disclosed. The grommet includes a tubular portion including a frustoconical segment and a first circular segment. The frustoconical segment includes a at least one opening within a frustoconical surface, where the at least one opening forms one or more flanges. The tubular portion is configured to be inserted into a cabin through a cabin opening while forming an interference fit between the frustoconical segment and the first circular segment with the cabin opening to prevent ingress of water into the cabin. The one or more flanges are configured to be compressed upon insertion in the cabin opening, and expanded after reaching an inner side of the cabin. The present grommet with a flexible and cost-effective self-lock design connects to an external roof harness.

### FIELD OF INVENTION

Embodiments of the present disclosure relate to grommets, and more particularly to a self-lock grommet for a construction machinery.

### BACKGROUND

Wire harness arrangement for a construction machinery have recently become more complicated and versatile as there has been huge advancement in mounting of various electrical components on vehicles. Such a situation requires a wide use of parts for wire harness protection or maintenance to avoid interference with peripheral parts, where grommets may be used for penetrating through openings provided in a machinery panel. The grommets are used to prevent tearing or abrasion of pierced material, provide protection from abrasion of insulation on wire, cable, line, and the like being routed through the openings, and cover sharp edges of the openings. Various types of grommet designs have been utilized by the construction machinery to address the aforementioned problems.

One such type of conventional design includes a bulkhead type connector which is designed to be inserted into a panel cutout from a rear header or a front side of the panel of the construction machinery. However, the bulkhead type connector used on the rear header to connect an external roof harness and an internal roof harness may lead to an expensive solution for accommodating the wire harnesses.

With the advancement in technology, a hole with a flexible grommet design has been used to accommodate the wire harnesses in the construction machinery. Such design requires the grommet to be coaxially and centrally positioned into the hole. However, in order to do so, a predetermined amount of force needs to be applied to push the grommet into the hole so as to pass through the hole, thereby elastically deforming a portion of the grommet which may lead to improper locking with the hole. As a result, the improper locking results in occurrence of a gap between the grommet and the panel of the construction machinery, which may in turn allow ingress of water through the gap.

US Application bearing number US2013/0061424A1 ('424 reference) discloses a waterproof grommet mounted on a cab of a construction machine. The waterproof grommet of the 424 reference may prevent entry of water inside the construction cabin, however configuration of the grommet and complexities in assembly of the grommet to a harness may be prohibitively expensive. This may cause excessive time-consumption at the time of grommet assembly and downtime during maintenance.

Hence, there is a need for an improved design of the grommet to address the one or more aforementioned issue(s) and other problems associated with conventional grommet assembly.

### BRIEF DESCRIPTION

In accordance with an embodiment of the present disclosure, a grommet is provided. The grommet includes a tubular portion. The tubular portion includes a frustoconical segment extruded at a first reference location of the tubular portion located towards a proximal end of the tubular portion. The frustoconical segment is configured to protrude towards a distal end of the tubular portion. The frustoconical segment includes at least one opening within a frustoconical surface of the frustoconical segment. The at least one opening is configured to form one or more of flanges. The tubular portion also includes a first circular segment extruded at a second reference location of the tubular portion. The first circular segment is configured to be perpendicular to the tubular portion. The first circular segment is located at a predefined distance from a distal end of the frustoconical segment. The proximal end of the tubular portion is configured to be inserted into a cabin through a cabin opening by forming an interference fit between the frustoconical segment and the first circular segment with the cabin opening, thereby preventing ingress of water via the cabin opening into the cabin. The one or more flanges is configured to have a first state representative of an expanded shape and a second state representative of a compressed shape. The one or more flanges attains the second state when compressed during insertion in the cabin opening, further the one or more flanges attains the first state after reaching an inner side of the cabin to form the interference fit with the first circular segment and the cabin opening.

In accordance with another embodiment of the present disclosure, a harness assembly is provided. The harness assembly includes an external roof harness mounted into a through hole of a machine carriage panel and a grommet. The grommet includes a tubular portion. Further, the tubular portion includes a frustoconical segment extruded at a first reference location of the tubular portion located towards a proximal end of the tubular portion and configured to protrude towards a distal end of the tubular portion. The frustoconical segment includes at least one opening within a frustoconical surface of the frustoconical segment. The at least one opening is configured to form one or more flanges. The tubular portion includes a first circular segment extruded at a second reference location of the tubular portion. The first circular segment is located at a predefined distance from a distal end of the frustoconical segment. The tubular portion also includes a second circular segment extruded at the second reference location of the tubular portion adjacent to the first circular segment. The first circular segment and the second circular segment are configured to define a stepped configuration.

In accordance with yet another embodiment of the present disclosure, a method of assembling a grommet on a machine carriage panel is provided. The method includes abutting the grommet on a cabin opening extending from a first side of the machine carriage panel to a second side of the machine carriage panel. The method also includes pushing the grommet via the cabin opening to compress one or more flanges of the grommet to attain a second state. The method further includes passing one or more flanges in the first state to the second side of the machine carriage panel by inserting the grommet via the cabin opening, thereby enabling an expansion of one or more flanges upon reaching the second side to attain a first state and forming an interference fit.

### BRIEF DESCRIPTION OF THE DRAWINGS

The disclosure will be described and explained with additional specificity and detail with the accompanying figures in which:

FIG. 1 is a side view of a backhoe loader machine having a grommet shown in a blown-up view in accordance with an embodiment of the present disclosure.

FIG. 2 is a perspective view of a grommet in accordance with an embodiment of the present disclosure;

FIG. 3 is a partial cross-sectional view of the grommet depicting one embodiment of a first circular segment of FIG. 2 in accordance with an embodiment of the present disclosure;

FIG. 4 is a cross sectional view of the grommet depicting various dimensions in accordance with an embodiment of the preset disclosure;

FIG. 5 is a cross sectional view of one embodiment of the harness assembly including grommet in accordance with an embodiment of the present disclosure;

FIG. 6 is a rear view of harness assembly depicting attachment of the external roof harness with the cabin through the grommet in accordance with an embodiment of the present disclosure;

FIG. 7 is perspective view of the grommet during a first stage of insertion into the cabin in accordance with an embodiment of the present disclosure;

FIG. 8 is a perspective view of the grommet during a second stage of insertion and approaching a locking condition in accordance with an embodiment of the present disclosure; and

FIG. 9 is a perspective view of the grommet during a final stage of the locking condition in accordance with an embodiment of the present disclosure.

### DETAILED DESCRIPTION

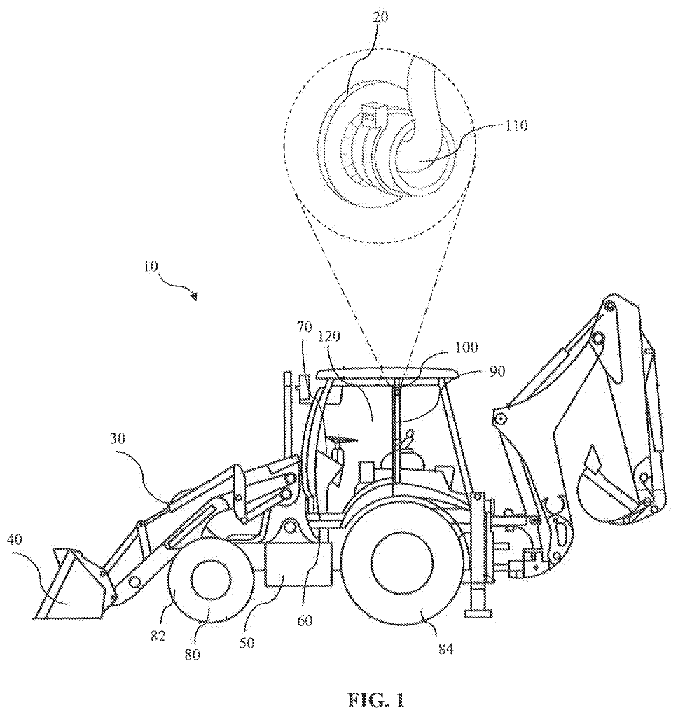

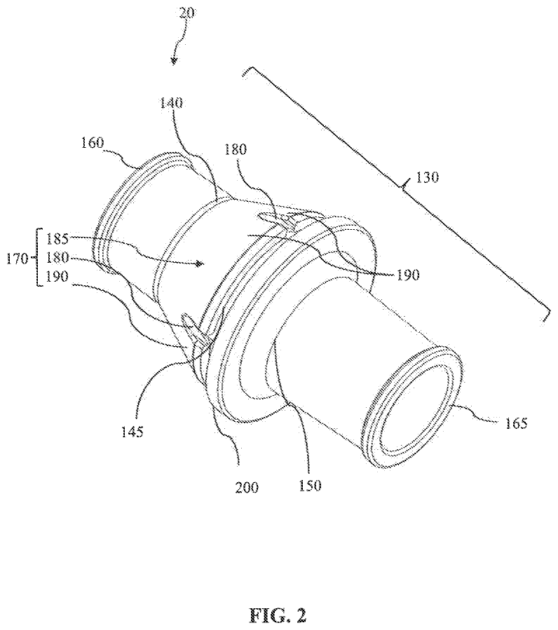

Referring to FIG. 1, there is shown a backhoe loader machine 10 having a grommet 20. The backhoe loader machine 10 further includes a loader work device 30 operatively coupled to a loader bucket 40. The loader bucket 40 may be configured to move and rotate to scoop up a required material inside the loader bucket 40. The backhoe loader machine 10 also includes a backhoe loader device operation unit 50 for operating the backhoe loader machine 10. The backhoe loader device operation unit 50 may include a lever 60 to operate the loader work device 30 and the loader bucket 40. The backhoe loader machine 10 further includes a driving unit 70 including a plurality of wheels 80. The plurality of wheels 80 may include at least two front wheels 82 and at least two rear wheels 84 attached to an axle of the driving unit 70 for movement of the backhoe loader machine 10, where the at least two rear wheels 84 are larger in size than the at least two front wheels 82. The backhoe loader machine 10 further includes a machine carriage panel 90 coupled to the driving unit 70. The machine carriage panel 90 includes a through hole 100 to mount an external roof harness 110. The machine carriage panel 90 is provided with a space 120 for an operator to sit and operate the backhoe loader machine 10. The backhoe loader machine 10 further includes the grommet 20 which is configured to house the external roof harness 110. In alternate embodiments, the grommet 20 may be used in other machines, heavy vehicles, and the like. The grommet 20 is further described in detail in FIG. 2.

Referring to FIG. 2, there is shown the grommet 20 including a tubular portion 130 configured to house the external roof harness 110. The tubular portion 130 includes a first reference location 140, a second reference location 150, and a proximal end 160 and a distal end 165. The tubular portion 130 includes a frustoconical segment 170 extruded at the first reference location 140 of the tubular portion 130 located towards the proximal end 160 of the tubular portion 130. The frustoconical segment 170 is configured to protrude towards the distal end 165 of the tubular portion 130. The frustoconical segment 170 includes a at least one opening 180 within a frustoconical surface 185 of the frustoconical segment 170. The at least one opening 180 is disposed circumferentially and defined by the frustoconical surface. The at least one opening 180 are configured to divide the frustoconical surface 185 to form one or more flanges 190. In an embodiment, the at least one opening 180 is located at an equal distance from each other within the frustoconical surface 185. As a result, in such embodiment the one or more flanges 190 are also located at an equal distance from each other. The one or more flanges 190 may be separated at a distal end 145 by the at least one opening 180 provided between each of the one or more flanges 190. The tubular portion 130 also includes a first circular segment 200 extruded at the second reference location 150 of the tubular portion 130. In one embodiment, the first circular segment 200 may be defined by a ring-like shape.

In an embodiment, the proximal end 160 of the tubular portion 130 is configured to be inserted into a cabin through a cabin opening by forming an interference fit between the frustoconical segment 170 and the first circular segment 200 with the cabin opening. The interference fit so formed prevents ingress of water via the cabin opening into the cabin.

In another embodiment, the tubular portion 130 including the frustoconical segment 170 and the first circular segment 200 is fabricated with a resilient material such as rubber or the like, thereby allowing the one or more flanges 190 to be compressed when applied with pressure. The one or more flanges 190 is configured to have a first state representative of an expanded shape of the one or more flanges 190 and a second state representative of a compressed shape of the one or more flanges 190. The one or more flanges 190 attains the second state when compressed during insertion in the cabin opening. Subsequently, the one or more flanges 190 expands and attains the first state after reaching an inner side 280 of the cabin 270, when pressure is removed, to form the interference fit with the first circular segment 200 and the cabin opening 220.

The frustoconical segment 170 is provided in the first state before being inserted in the cabin opening. In a specific embodiment, the one or more flanges 190 of the frustoconical segment 170 are tapered and configured to provide a one-way locking arrangement.

In yet another embodiment, the tubular portion 130 is configured to have an undercut 235 below the one or more flanges 190 thereby creating space to allow compression of the one or more flanges 190 during the insertion in the cabin opening.

In an embodiment, the at least one opening 180 between each of the one or more flanges 190 facilitate compression of the one or more flanges 190 without overlapping, thereby enabling easy passage of the one or more flanges 190 during insertion within the cabin opening 220.

In another embodiment, the one or more flanges 190 may also be reinforced with strengthening materials or one or more support structures to prevent backward bending of the one or more flanges 190 under a force exerted by the movement of the cabin.

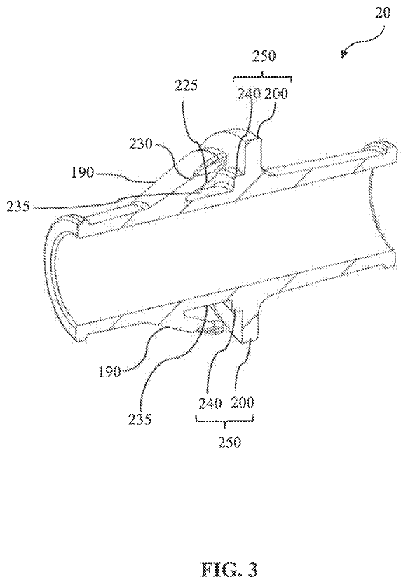

Referring to FIG. 3, in another embodiment, the tubular portion 130 includes a second circular segment 240 extruded at the second reference location 150 of the tubular portion 130. In such an embodiment, the second circular segment 240 is positioned closely next to the first curler segment 200. The first circular segment 200 and the second circular segment 240 are configured to define a stepped configuration 250. The first circular segment 200 includes a first diameter, and the second circular segment 240 includes a second diameter. In such an embodiment, the first diameter is greater than the second diameter. The second circular segment 240 is configured to fit within the cabin opening while the first circular segment 200 is configured to fit with the cabin. The stepped configuration 250 causes the cabin opening to be sealed with a two-stage protection, offered by the first diameter and the second diameter, from the ingress of water.

In such an embodiment, the second diameter of the second circular segment 240 is configured to match with a diameter of the cabin opening. The one or more flanges 190 may be defined by an inner diameter 225 and an outer diameter 230. The outer diameter of the one or more flanges 190 is adapted to match with the second diameter of the second circular segment 240 during the compressed state for insertion through the cabin opening.

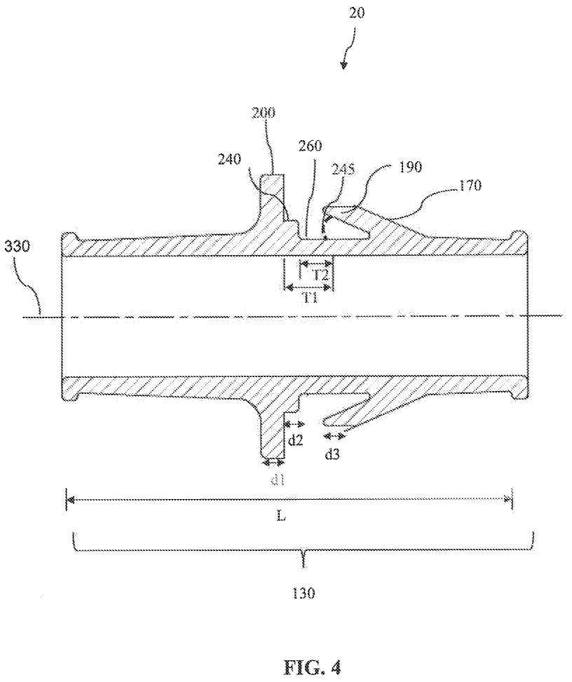

Referring to FIG. 4, there is shown various dimensions of the grommet 20. The tubular potion 130 including the frustoconical segment 170 having the one or more flanges 190, the first circular segment 200, and the second circular segment 240 may include a predefined length, width, size and angle. In one embodiment, the predefined length of the grommet 20 is L. In an exemplary embodiment, the one or more flanges 190 may be positioned at an angle 245 of about 24.3 degrees with respect to an outer surface 260 of the tubular portion 130 or a central axis 330 of the tubular portion 130. In an embodiment, a width dl of the first circular segment 200 may be greater, equal or lesser than a width d2 of the second circular segment 240. The width d2 of the second circular segment 240 may match with a width of a panel of the cabin. In another embodiment, a width d3 of the one or more flanges 190 may match with the second diameter of the second circular segment 240. The first circular segment 200 is located at a predefined distance T1 from the distal end the frustoconical segment 170. The second circular segment 240 is located at a predefined distance T2 from the distal end of the frustoconical segment 170. In one embodiment, the predefined distance T1 may be defined by a width of sheet metal of the cabin. The aforementioned dimensions are merely exemplary in nature and not intended to limit the disclosure or the application and uses of the disclosure.

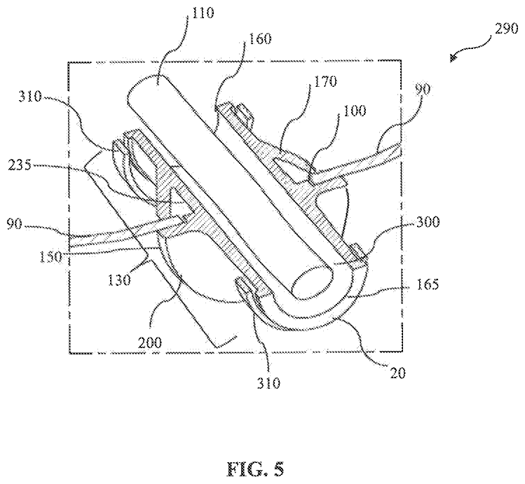

Referring to FIG. 5, there is shown a harness assembly 290 including the grommet 20. The grommet 20 is configured to pass via the through hole 100 and form an interference fit with the machine carriage panel 90. The harness assembly 290 includes the external roof harness 110 which is mounted into the through hole 100 of the machine carriage panel 90. The tubular portion 130 includes the frustoconical segment 170 protruding externally from the first reference location 140 of the tubular portion 130. The tubular portion 130 also includes the first circular segment 200 positioned at the second reference location 150 of the tubular portion 130. The tubular portion 130 further includes an annular region 300 which is configured to house the external roof harness 110. More specifically, the distal end 160 of the tubular portion 130 acts as an entry point for the external roof harness 110 while the proximal end 165 of the tubular portion 130 acts as an exit point for the external roof harness 110. In an embodiment, the proximal end 160 and the distal end 165 of the tubular portion 130 are configured to be sealed, while housing the external roof harness 110, with help of one or more wire tags 310.

The annular region 300 of the tubular portion 130 protects the external roof harness 110. The external roof harness 110 is formed in a manner that, for example, a plurality of wiring materials used in the connection between devices to be mounted in the backhoe loader machine 10 (FIG. 1) for power supply or signal communication are bundled into an assembly. In one embodiment, the external roof harness 110 may include the wiring material which is conductive, and the grommet 20 is provided to the wiring material and has the wiring material inserted thereinto. In such an embodiment, the wiring material may be formed of a metal bar, an electric wire, an electric wire bundle, and the like. In a specific embodiment, the grommet 20 may be fabricated from a material or a mixture of materials including, but not limited to, rubber material which has low rigidity and high flexibility.

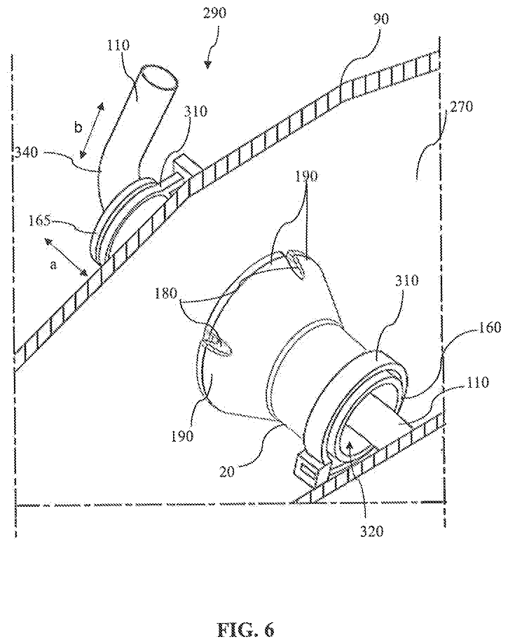

Referring to FIG. 6, there is shown the harness assembly 290 depicting locking of the grommet 20. The grommet 20 is shown assembled to the machine carriage panel 90 of the cabin 270 in a state where the external roof harness 110 of the harness assembly 290 is inserted into the grommet 20 and the grommet 20 is externally attached to the external roof harness 110. The grommet 20 includes the tubular portion 130 with the proximal end 160 and the distal end 165. The proximal end 160 and the distal end 165 are sealed using a corresponding wire tag 310. In an embodiment, the wire tag 310 may be an external damper. The corresponding wire tag 310 is fastened such that an inner surface 320 of the grommet 20 is adapted to form a tight contact with the external roof harness 110. Thus, the grommet 20 protects the external roof harness 110 that passes via the cabin opening 220 and prevents water from entering in the cabin opening 220 as well. The external roof harness 110 is wired linearly along an axial direction “a” which is aligned with the central axis 300 of tubular portion 130. However, structure of the external roof harness 110 is not limited thereto. For example, in a state where the grommet 20 is attached to the cabin 270, the axial direction “a” may bent in a direction “b” and the external roof harness 110 may also be bent partially forming a bent 340. The aforementioned directions correspond to the directions in the state where the grommet 20 is assembled to the cabin 270 unless otherwise stated.

In an embodiment of the present disclosure, a method 200 for assembling the grommet 20 on the machine panel 90 is provided. The method 200 includes abutting the grommet 20 on a cabin opening 220 extending from a first side 275 of the machine carriage panel 90 to a second side 280 of the machine carriage panel 90 at the step 410. The first side 275 represents an external side of the machine carriage panel 90 and the second side 280 represents an internal side of the machine carriage panel 90.

The one or more flanges 190 of the grommet 20 are configured to have a first state and a second state. The first state of the one or more flanges represents an expanded shape of the one or more flanges, and the second state of the one or more flanges represents a compressed shape of the one or more flanges.

In an embodiment, the method includes pushing the grommet 20 via the cabin opening 220 to compress one or more flanges 190 of the grommet 20 to attain the second state at the step 420.

In an embodiment, the method includes passing one or more flanges 190 in the first state to the second side 280 of the machine carriage panel 90 by inserting the grommet 20 via the cabin opening 220 at step 420. The passing of the one or more flanges 190 across the cabin opening 220 enable an expansion of the one or more flanges 190 upon reaching the second side 280 hence attaining first state and, thereby forming an interference fit. In such embodiment, the interference fit is formed between a second circular segment 240 of the grommet 20 and the first side 275 of the machine carriage panel 90 while a first circular segment 200 of the grommet 20 covers the cabin opening 220 from the first side 275, and the one or more flanges 190 abut the second side 280 of the machine carriage panel 90 while overlaying the cabin opening 220.

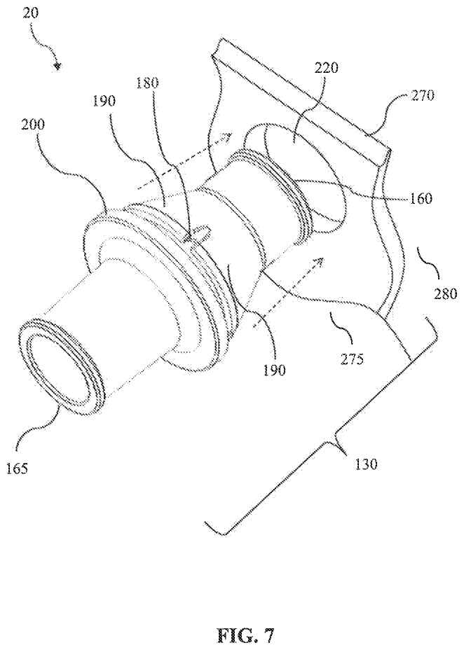

Referring to FIG. 7, there is shown a first step of insertion of the grommet 20 with the cabin 270 via the cabin opening 220. A set of dotted arrows depicts a direction of insertion of the proximal end 160 of the tubular portion 130. The one or more flanges 190 formed by the at least one opening 180 are in the first state. Further, the first circular segment 200 and the one or more flanges 190 are still not engaged with the machine carriage panel 90 of the cabin 270, and the distal end 165 of the tubular portion 130 is facing the first side 275.

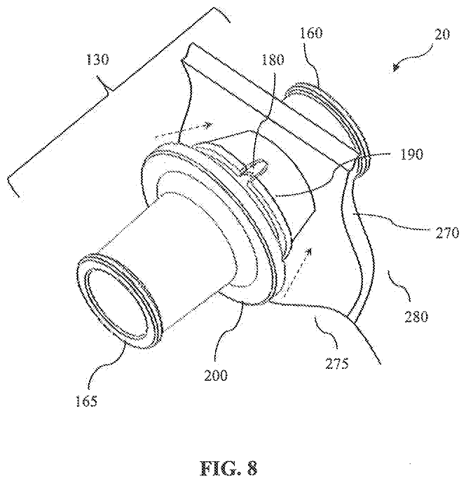

Referring to FIG. 8, there is shown a second or a middle step of the insertion of the grommet 20, where the grommet 20 is inserted till midway. A set of dotted arrows depicts a direction of insertion of the tubular portion 130. The proximal end 160 is shown to have passed via the cabin opening 220. An engagement of the one or more flanges 190 with the cabin 270 during the insertion creates pressure over the one or more flanges 190, thus causing the compression of the one or more flanges 190 and enable attaining of the second state the one or more flanges 190. In the second state, the one or more flanges 190 bends downward and may come in contact with the outer surface 260 of the tubular portion 130 or the undercut 235 below the one or more flanges 190, thereby allowing easy passage of the grommet 20 via the cabin opening 220.

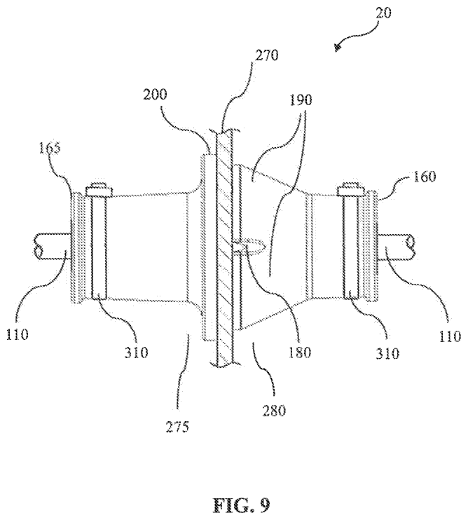

Referring to FIG. 9, there is shown a third or final stage of insertion of the grommet 20, where the grommet 20 is completely inserted and locked with the machine carriage panel 90 of the cabin 270. The one or more flanges 190 are shown to have completely passed via the cabin opening 220 and engaged with cabin 270 forming the one-way locking arrangement. The one or more flanges 190 expand and regain the first state after reaching the inner side 280, thereby forming the interference fit.

Various embodiments of the grommet disclose a flexible and cost-effective self-lock design of the grommet which is configured to connect to the external roof harness with a platform harness by eliminating additional internal roof harness. The present embodiments of the grommet also effectively solve the problem of ingress of water during washing etc. Consequently, the elimination of internal roof harness leads to a low-cost solution without affecting performance. Flexible tapered flanges of the grommet provide an easy entry of the grommet in the opening of the cabin and one-way locking. The at least one opening is added to the flanges to enable compression effect for easy entry. The stepped configuration formed by the first circular segment and the second circular segment ensures nearly 100% contact with the cabin opening devoid of any space, thus prevents entry of water inside the cabin while suppressing the deterioration in workability in assembling the grommet. The self-locking and the assembly process of the external roof harness has been improved additionally to interact with the grommet. Additionally, there is no need for a special tool for installation or removal of the grommet. The grommet may be easily installed or removed from the cabin by manual efforts.

### INDUSTRIAL APPLICABILITY

The disclosed grommet is used to cover rough and sharp edges of a hole in a metal sheet part of a construction during manufacturing or production of related machinery. For this particular type of application or process, the grommet fabricated with a resilient material is used. More specifically, the grommets are used to prevent tearing or abrasion of the pierced material or protection from abrasion of insulation on the wire, harness, cable, line, and the like being routed through a hole, and to cover sharp edges of piercing. The grommet may be easily assembled on the machine panel by inserting the same via the cabin opening of the machine carriage panel. Once inserted, the grommet forms the interference fit between the second circular segment of the grommet and the machine carriage panel. The interference fit mechanism of the grommet prevents ingress of water or any other material inside the machinery. The grommet may be used in machinery such as backhoe loader, bulldozer, wheel loader, excavator, integrated tool carrier, landfill compactor, track-type tractor, truck, hydraulic control, and the like. Additionally, grommets are also important parts in automotive applications, where the grommet is used to protect lines, wires and cables from chafing or grazing on rough surfaces. The grommet may also effectively reduce vibration and are used to seal different important under-the-hood and body applications.

What is claimed is:

1. A grommet comprising:
a tubular portion comprising:
a frustoconical segment extruded at a first reference location of the tubular portion located towards a proximal end of the tubular portion and configured to protrude towards a distal end of the tubular portion, wherein the frustoconical segment comprises at least one opening within a frustoconical surface of the frustoconical segment, wherein the at least one opening is configured to form one or more flanges;
a first circular segment extruded at a second reference location of the tubular portion, wherein the first circular segment is located at a predefined distance from a distal end of the frustoconical segment, and
a second circular segment extruded at the second reference location of the tubular portion adjacent to the first circular segment, wherein the first circular segment and the second circular segment are configured to define a stepped configuration.

2. The grommet as claimed in claim 1, wherein the one or more flanges are equidistant from each other.

3. The grommet as claimed in claim 1, wherein the first circular segment of the tubular portion is configured to be perpendicular to a central axis of the tubular portion.

4. The grommet as claimed in claim 1, wherein the tubular portion is configured to have an undercut below the one or more flanges to allow compression of the one or more flanges during the insertion in the cabin opening.

5. The grommet as claimed in claim 1, wherein the predefined distance from the first reference location of the frustoconical segment is defined by a width of the cabin.

6. The grommet as claimed in claim 1, wherein the first circular segment comprises a first diameter and the second circular segment comprises a second diameter, wherein the first diameter is greater than the second diameter.

7. The grommet as claimed in claim 1, wherein the second circular segment is configured to fit within the cabin opening and the first circular segment is configured to fit with the cabin to provide a two-stage protection from the ingress of water.

8. The grommet as claimed in claim 1, wherein the tubular portion is configured to house an external roof harness.

9. The grommet as claimed in claim 1, wherein the proximal end and the distal end of the tubular portion are configured to be sealed, while housing the external roof harness, with a wire tag.

10. A harness assembly comprising:
an external roof harness mounted into a through hole of a machine carriage panel;
a grommet comprising:
a tubular portion comprising:
a frustoconical segment extruded at a first reference location of the tubular portion located towards a proximal end of the tubular portion and configured to protrude towards a distal end of the tubular portion, wherein the frustoconical segment comprises at least one opening within a frustoconical surface of the frustoconical segment, wherein the at least one opening is configured to form one or more flanges; and
a first circular segment extruded at a second reference location of the tubular portion, wherein the first circular segment is located at a predefined distance from a distal end of the frustoconical segment,
wherein the tubular portion comprises a second circular segment extruded at the second reference location of the tubular portion adjacent to the first circular segment, wherein the first circular segment and the second circular segment are configured to define a stepped configuration.

11. A method of assembling of a grommet on a machine carriage panel comprising:
abutting the grommet on a cabin opening extending from a first side of the machine carriage panel to a second side of the machine carriage panel;
pushing the grommet via the cabin opening to compress one or more flanges of the grommet to attain a second state; and
passing one or more flanges in the first state to the second side of the machine carriage panel by inserting the grommet via the cabin opening, thereby enabling an expansion of one or more flanges upon reaching the second side to attain a first state and forming an interference fit,
wherein the interference fit is formed between a second circular segment of the grommet and the first side of the machine carriage panel while a first circular segment of the grommet covers the cabin opening from the first side, and the one or more flanges abut the second side of the machine carriage panel while overlaying the cabin opening.

12. The method as claimed in claim 11, wherein the first side represents an external side of the machine carriage panel and the second side represents an internal side of the machine carriage panel.

13. The method as claimed in claim 11, wherein the first state of the one or more flanges represents an expanded shape of the one or more flanges, and the second state of the one or more flanges represents a compressed shape of the one or more flanges.
